(19) United States
(12) Patent Application Publication
(10) Pub. No.: US 2006/0193267 A1
(43) Pub. Date: Aug. 31, 2006

(54) Method and system for transporting multiple signal types using variable size frames

(76) Inventors: Rajive Dhar, Fremont, CA (US); Anita Chowdhry, Fremont, CA (US); Rajesh Subramaniam, Fremont, CA (US)

Correspondence Address: ARRIS INTERNATIONAL, INC, 3871 LAKEFIELD DRIVE, SUWANEE, GA, 30024, US

(21) Appl. No.: 11/358,361

(22) Filed: Feb. 21, 2006

Related U.S. Application Data
(60) Provisional application No. 60/654,290, filed on Feb. 18, 2005.

(51) Int. Cl. H04L 12/16; H04Q 11/00

(52) U.S. Cl. 370/264

(57) ABSTRACT

An input detector detects the bit rate and signal type of multiple signals at corresponding multiple interface ports. A master controller coupled to the detector sends control signals to different types of framers such that signals received at one of the multiple interface ports is operated on by a framer corresponding to the signals format type. In addition, an Ethernet aggregator may combine multiple Ethernet frames of different sizes into a single frame so when it is mapped into a SONET frame, essentially all of the SONET frame is used. A SONET mapper generates and inserts information into a frame that identifies the contents of the information contained therein. At a receiving end, the mapper can determine from this information the contents, and can instruct a controller which framer/unframer to send the frame information to.

### CROSS REFERENCE TO RELATED APPLICATION

This application claims priority under 35 U.S.C. 119(e) to U.S. provisional patent application No. 60/654,290 entitled “Multi-frame-type 10G Ethernet Transport,” which was filed Feb. 18, 2005, and is incorporated herein by reference in its entirety.

### FIELD OF THE INVENTION

This invention relates, generally, to communication networks and devices and, more particularly, to transporting multiple signal types over a 10G Ethernet network using variable size frames.

### BACKGROUND

SONET to transport information over a backbone transport network. Ethernet frames received from a distribution network are typically carried in a SONET frame over the transport network. SONET, or SONET over DWDM, is the predominant protocol of choice used to transport various data formats (DS1, DS3, 10 Mbps, 100 Mbps, 1 Gbe). Various data formats are mapped into a SONET frame (which is of fixed size) and transported over a network. Depending on the frame size (typically a 51 Mbps frame size or STS-1 or 155 Mbps frame size or STS-3c are used), transport of various data formats can result in inefficiencies within the network, i.e., a 51 Mbps frame can be used to carry a 10 Mbps or 155 Mbps frame can be used to carry a 100 Mbps payload resulting in 80% or 66% inefficiency for example. The inefficiencies of SONET to carry data are well understood. The inefficiencies result from use of a fixed frame size to transport data.

Thus, there is a need in the art for a method and system that can carry multiple signal format types over a transport network without substantially reducing transport conversion efficiency. Furthermore, there is a need in the art for a method and system for transporting a variety of signal format types using the same multiplexed carrier, such as, for example, a single wavelength on an optical transport network.

### BRIEF DESCRIPTION OF DRAWINGS

FIG. 1 illustrates a system for transporting various traffic types over a transport network.

FIG. 2 illustrates a flow diagram for detecting a type of traffic and converting the traffic information into SONET frames.

### DETAILED DESCRIPTION

As a preliminary matter, it will be readily understood by those persons skilled in the art that the present invention is susceptible of broad utility and application. Many methods, embodiments and adaptations of the present invention other than those herein described, as well as many variations, modifications, and equivalent arrangements, will be apparent from or reasonably suggested by the present invention and the following description thereof, without departing from the substance or scope of the present invention.

Accordingly, while the present invention has been described herein in detail in relation to preferred embodiments, it is to be understood that this disclosure is only illustrative and exemplary of the present invention and is made merely for the purposes of providing a full and enabling disclosure of the invention. The following disclosure is not intended nor is to be construed to limit the present invention or otherwise to exclude any such other embodiments, adaptations, variations, modifications and equivalent arrangements, the present invention being limited only by the claims appended hereto and the equivalents thereof.

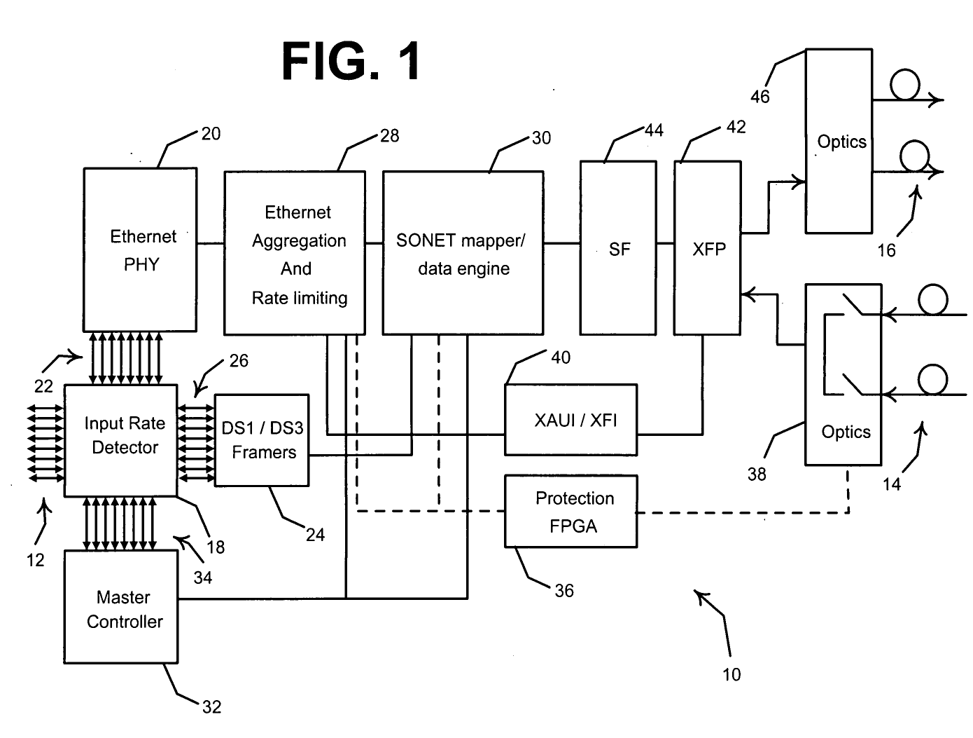

Turning to FIG. 1, a system 10 is shown the receives and transmits traffic signal streams at a plurality of distribution ports 12. It will be appreciated that the term distribution is used to distinguish one side of system 10 at ports 12, from the other side, referred to as the transport side, which is at optical input and output ports, ports 14 and ports 16, respectively, as referenced in the figure.

Distribution ports 12 are coupled with input rate detector 18, which detects the bit rate of a stream of distribution units, which typically corresponds to traffic type, such as, for example, Ethernet, gigabit Ethernet, DS1, DS3, STS-1, DVB-ASI and MPEG, to name a few of the various types of traffic signals that may be detected by rate detector 18. Ethernet data interfaces with Ethernet PHY 20 via Ethernet ports 22. DS1/DS3 traffic data interfaces with DS1/DS3 framer 24 via DS ports 26. In the upstream direction, which for purposes of discussion refers to traffic moving from ports 12 toward ports 16, Ethernet traffic is forwarded to an Ethernet aggregation and rate limiting component 28, where frames are formatted and prepared for conversion into SONET compatible frames by mapper 30. Mapper 30 is a data engine that can determine the size of a frame and generate identifier information for insertion into a transport unit, such as, for example, a SONET frame, that may deviate from a standard size SONET frame. In the receive direction, mapper 30 can determine the type of data included in a SONET frame, regardless of the frame size, and forward to the appropriate component.

Aggregation component 28 and SONET mapper 30 are controlled by master controller 32, which receives control information via controller ports 34. It will be appreciated that aggregation component 28 and mapper 30 may also receive traffic control information from protection FPGA 36, based on received traffic (downstream direction) at receive optics component 38. Aggregation component 28 may also receive control information from 10 gigabit attachment unit interface/serial interface (“XAUI/XFI”), which is coupled to small form factor pluggable component (“XFP”) 42. Mapper 30 is coupled to SF 44, which is coupled to XFP 42. XFP interfaces SF 44 with receive optics 38 and transmit optics 46, which provides information that was received at ports 12 in one of a plurality of different formats, in an optical OC192 format, for example.

Traffic determined by detector 18 to be DS traffic is framed by framer 24 and forwarded to SONET mapper 30, thus bypassing Ethernet PHY 20 and Ethernet aggregation component 28. Thus, regardless of traffic type, traffic packets, or frames, or whatever other format that may be received at ports 12 is provided to SONET mapper 30 for transport over a transport network by transmit optics 46 from transmit ports 16.

In the downstream direction, SONET frames received at ports 14 arrive at mapper 30. SONET mapper determines they type of payload contained in the SONET frame and informs master controller 32 of timing and size information. Ethernet data is provided to aggregation and rate limiting component 28 and DS data is provided to framers 24. Master controller instructs detector 18 to pass-thru information signals to an appropriate one of the plurality of ports 12.

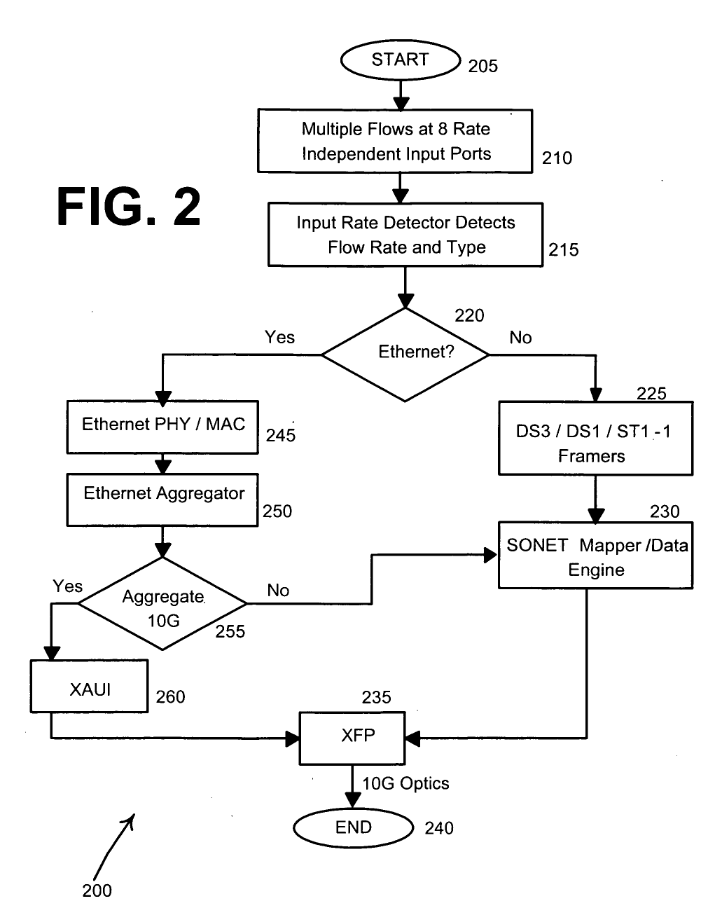

Turning now to FIG. 2, a flow diagram of a method 200 for transporting multiple traffic types over SONET is illustrated. It will be appreciated that reference to components described in reference to FIG. 1 above may be made.

Method 200 starts at step 205 and different traffic type flows may be received at one or more of the rate independent ports 12 at step 210. Input rate detector 18 detects the flow rate and traffic type of the incoming signal on each of the ports 12 at step 215. For each information unit, whether it is a packet, or a frame, or other data transport format, a determination is made at step 220 whether the information format is Ethernet. If not, then the information unit is sent to DS framer 24, which is also capable of operating on STS-1 information, at step 225.

As step 230, SONET mapper 30, under control of controller 32 maps the information unit(s) received at one of ports 12 into a SONET frame in one of a plurality of increments, preferably in increments of 1.5 Mbps or 51 Mbps. Then, the SONET frame is provided to XFP 42 at step 235 and the process ends at step 240.

Returning to the decision made at step 220, if the information unit received at one of ports 12 is determined to be in an Ethernet format, the information unit is forwarded to Ethernet PHY 20 at step 245. At step 250, the information unit is provided to Ethernet aggregator 250. At step 255, a determination is made whether the aggregated Ethernet information unit is in 10G Ethernet format. If not, the Ethernet information unit is forwarded to SONET mapper 30 at step 230, and the process continues as previously described. If the determination is made at step 255 that the Ethernet information unit is 10G Ethernet, the 10G Ethernet frame is forwarded to XAUI at step 260, and then to XFP 42 at step 235. The process ends at step 240.

These and many other objects and advantages will be readily apparent to one skilled in the art from the foregoing specification when read in conjunction with the appended drawings. It is to be understood that the embodiments herein illustrated are examples only, and that the scope of the invention is to be defined solely by the claims when accorded a full range of equivalents.

What is claimed is:

1. A method for transporting signals of different types over a transport network, comprising:
receiving an information signal in one of a plurality of predetermined base formats at one of a plurality of distribution side input ports, the signal comprising data in one or more predetermined distribution units according to the predetermined format;
determining the predetermined format of the received information signal;
converting each information signal distribution unit into a transport unit, wherein more than one information unit may be converted into a single transport unit; and
providing each transport unit at a transport side output port.

2. The method of claim 1 wherein the transport network is an optical network.

3. The method of claim 2 wherein the all transport units are provided at the transport network output port at the same wavelength.

4. The method of claim 1 further comprising inserting an indicator into each transport unit to identify the base format type of the distribution unit from which it was converted.

5. The method of claim 1 further comprising:
receiving an information signal comprising a plurality of transport units at a transport network input port;
determining the base format of the distribution unit from which a transport unit was converted for each transport unit of the received information signal;
converting each transport unit into a distribution unit according to the base format of the distribution unit from which it was converted; and
providing each distribution unit to one of a plurality of distribution outputs coupled to a distribution network.

6. A system for transporting signals of different types over a transport network, comprising:
means for receiving an information signal in one of a plurality of predetermined base formats at one of a plurality of distribution side input ports, the signal comprising data in one or more predetermined distribution units according to the predetermined format;
means for determining the predetermined format of the received information signal;
means for converting each information signal distribution unit into a transport unit, wherein more than one information unit may be converted into a single transport unit; and
means for providing each transport unit at a transport side output port.

7. The system of claim 6 wherein the transport network is an optical network.

8. The system of claim 7 wherein the all transport units are provided at the transport network output port at the same wavelength.

9. The system of claim 6 further comprising means for inserting an indicator into each transport unit to identify the base format type of the distribution unit from which it was converted.

10. The system of claim 6 further comprising:
means for receiving an information signal comprising a plurality of transport units at a transport network input port;
means for determining the base format of the distribution unit from which a transport unit was converted for each transport unit of the received information signal;
means for converting each transport unit into a distribution unit according to the base format of the distribution unit from which it was converted; and
means for providing each distribution unit to one of a plurality of distribution outputs coupled to a distribution network.
